(19) United States
(12) Patent Application Publication
(10) Pub. No.: US 2008/0208549 A1
(43) Pub. Date: Aug. 28, 2008

(54) Modelling Body Tissue Characteristics

(76) Inventors: Matthew Gaved, Cambridge (GB); Michael Farquharson, London (GB)

Correspondence Address: ARENT FOX LLP, 1050 CONNECTICUT AVENUE, N.W., SUITE 400, WASHINGTON, DC, 20036, US

(21) Appl. No.: 11/630,249

(22) PCT Filed: Jun. 27, 2005
(86) PCT No.: PCT/GB05/02499

§ 371 Date: Dec. 26, 2007

(30) Foreign Application Priority Data
Jun. 25, 2004 (GB) 0414320.2

(51) Int. Cl. G06G 7/60; G06F 17/30

(52) U.S. Cl. 703/11; 707/103 R; 707/E17.045

(57) ABSTRACT

The present invention describes a method of creating and/or updating a model that relates to at least one measurable tissue property to at least one tissue characteristic, the method comprising: defining two or more data categories; assigning each of a plurality of training data sets to one or more of the data categories; creating and/or updating the model using only data sets categorised in a selected one of the categories. The present invention also describes a method and system for creating such a model as well as a database structure for storing a plurality of measured tissue property data sets used by the model.

### FIELD OF THE INVENTION

The present invention relates to methods and systems for creating models of body tissue characteristics, which can be used for example to characterise body tissue as normal (e.g. healthy) or abnormal (e.g. pathological). The invention has particular, although not necessarily exclusive, applicability to the diagnosis and management of cancer, including breast cancer.

### BACKGROUND

In order to manage suspected or overt breast cancer, tissue is removed from the patient in the form of a biopsy specimen and subjected to expert analysis by a histopathologist. This information leads to the disease management program for that patient. The analysis requires careful preparation of tissue samples that are then analysed by microscopy for prognostic parameters such as tumour size, type and grade. An important parameter in tissue classification is quantifying the constituent components present in the sample. Interpretation of the histology requires expertise that can only be learnt over many years based on a qualitative analysis of the tissue sample, which is a process prone to inter and intra observer variability.

Despite the relative value of histopathological analysis, there remains a degree of imprecision in predicting tumour behaviour in the individual case. Additional techniques have the potential to fine-tune tissue characterisation to a greater degree than that currently used and hence will improve the targeted management of patients.

A number of different researchers have proposed the use of x-ray (or other penetrating radiation) diffraction profiles (referred to sometimes as “signatures”) to characterise tissue as normal or abnormal. The diffraction profile is the intensity of x-rays that are scattered (predominantly by diffraction effects) as a function of momentum transfer for a given tissue sample, and is characteristic of the tissue sample under investigation.

Examples include:
Poletti M. E., Goncalves O. D. and Mazzaro I 2002 X-ray scattering from human breast tissues and tissue equivalent materials. Phys. Med. Biol 47 375-82
Kidane G. Speller R. D., Royle G. J. and Hanby A. M. 1999 X-ray signatures form normal and neoplastic breast tissue Phys. Med. Biol 44 791-802

This approach has been shown to be successful to a degree. However, whilst it has proved possible to use this approach to distinguish normal and diseased tissue (because there are large differences in the diffraction profiles for adipose and other tissue types), it has not been possible to discriminate tissue types at a finer level (e.g. to distinguish benign and malignant tumours).

In co-pending PCT patent application PCT/GB04/005185, we describe a multivariate approach to characterising/analysing body tissue. The approach described in that application is to use a multivariate model that relates the multiple, measured inputs to specific tissue characteristics. More specifically data measured from tissue samples, for which the characteristics to be modelled are known, is used to create a model that can be subsequently used to predict one or more unknown characteristics of other samples. The models can be created, for example, using a Partial Least Squares (PLS) regression approach or a Principal Component Analysis (PCA) approach, examples of which are well known in the computer modelling field.

The techniques that are used to obtain the tissue data for the model can include include a variety of measured tissue properties derived using x-rays and/or other penetrating radiations, including for example, x-ray fluorescence (XRF), Compton scatter and/or Compton scatter densitometry, energy dispersive x-ray diffraction (EDXRD), angular dispersive x-ray diffraction (including wide angle x-ray scattering (WAXS)), low angle x-ray scattering, small angle scattering (SAXS), and ultra low angle scattering (ULAX) and linear attenuation (transmission).

### SUMMARY OF THE INVENTION

The present invention is generally concerned with methods and systems for creating and making available models that can be used in the manner described in co-pending PCT patent application PCT/GB04/005185.

For the avoidance of doubt, hereinafter the term “tissue sample” is to be construed in a broad context. Specifically, this term is referred to within the context of the present invention to comprise in vivo “samples”, i.e. “samples” that are part of a living human or animal body. Additionally, this term is also referred to within the context of the present invention to comprise ex vivo (which may also be referred to as in vitro), non-uniform and uniform samples comprising all or part of a lump or segment or sample of tissue that has been removed from a patient. Non-uniform and uniform relates to the biological composition of the tissue.

Similarly, within the context of the present invention the term “tissue sample” is also understood to comprise biological body tissue of human or animal origin. The body tissue samples may be in vivo also, i.e. part of a living human or animal body. Alternatively, the body tissue samples may be an ex vivo (which may also be referred to as in vitro), preferably non-uniform, sample that has been obtained via a surgical procedure or veterinary procedure. Alternatively, the biological tissue sample may be obtained from cell cultures or cell lines. These cell cultures or cell lines may have been grown or propagated or developed in Petri dishes or the like.

In a first aspect, the invention provides a method of creating and/or updating a model that relates one or more (preferably two, three, four or more) measurable tissue properties to one or more tissue characteristics, the method comprising:
defining two or more data categories;
assigning each of a plurality of training data sets to one or more of the data categories;
creating and/or updating the model using only data sets categorised in a selected one of the categories.

The step of creating/updating the model can be accomplished in any of a number of suitable ways known in the computer modelling field. Two possible examples are those given in co-pending PCT patent application PCT/GB04/005185, discussed above. Other multivariate modelling techniques can be used, including for example neural modelling techniques.

The model can subsequently be used to characterise a tissue sample based on a set of measured tissue property data from the sample.

A data set will typically comprise multiple measured data values from a single tissue sample for which the tissue characteristic or characteristics the model is being built to determine are known. The multiple measured values are preferably from different types of measurement derived using x-rays and/or other pentrating radiations, including for example, x-ray fluorescence (XRF), Compton scatter and/or Compton scatter densitometry, energy dispersive x-ray diffraction (EDXRD), angular dispersive x-ray diffraction (including wide angle x-ray scattering (WAXS)), low angle x-ray scattering, small angle scattering (SAXS), and ultra low angle scattering (ULAX) and linear attenuation (transmission).

The data categories may, for example, include one or more properties of the tissue or the patient it has been obtained from, e.g:
the patient's age, sex, race, location, weight, whether they have carried a foetus, whether they are menopausal, etc;
the body part from which the sample comes;
the facility or facilities at which the sample was analysed/characterised;
the accuracy of the measured tissue property data (e.g. confidence level), etc;
histopathology data and/or histopathological diagnosis of tissue samples, such whether the tissue exhibits benign or maligant change etc;
tissue characteristics/types (e.g. adipose, glandular or fibrous; normal, abnormal benign, abnormal malignant);
patient history (e.g. medical history, family history, etc), but also other patient information such as previous or current treatments the patient has undergone. For instance, if the patient had pre-operative chemotherapy to reduce the size or proliferation of the tumour, it is likely that this would have an effect on the cellular composition and, thus, almost certainly the x-ray scattering signature. For this reason it may be advantageous or preferable to take into account recent and/or prior treatment information in the analysis and processing of data obtained from patient tissue samples and in the training model(s) and/or algorithms; and
Other tissue information more generally. Such “other tissue” information may include information about the genomic or proteomic composition/profile of the tissue. Of course, genomic or proteomic data would not be used as an immediate or relatively immediate parameter for the model(s) and/or algorithm(s), it may be utilised to train the model(s) and/or algorithm(s) or used on a sample for in vitro analysis.

For convenience the categories may be grouped into category types. For example a category type might be sex and contain the two categories ‘male’ and ‘female’. For convenience and consistency, the category types preferably each have a number of predefined categories within them (which may be exclusive—i.e. the category for a particular sample can only take one of these predefined values—or non-exclusive). For instance, the sex category type may have the possible category values ‘female’ and ‘male’, with no other options allowed.

The training data sets are preferably stored in a database with their assigned categories. New training data sets are categorised as they are added to the database. Each data set may be assigned to multiple categories, but will typically only have one value for each category.

In this way, a variety of models can be generated using the data, by selecting different groups of the data to create each model, the groups determined by specifying that the group data must have specific category values. For instance, a data group may comprise all data sets for tissue samples taken from females in the 20 to 30 age range, or all data sets for tissue samples from males that live in North America or Europe and for which the confidence level in the data is 95% or higher. Data groups used to create a model may also be formed by excluding certain categories of data or through a combination of including some categories and excluding others.

Accordingly, in a second aspect, the invention provides a method of creating a model that relates one or more (preferably two, three, four or more) measurable tissue properties to one or more tissue characteristics, the method comprising:
providing a database of training data sets, the data sets each being assigned to one or more of a plurality of categories;
defining a group of training data sets to be used to build a model, the group being defined with reference to two or more of the data categories; and
creating the model using the defined group of data sets.

In a third aspect, the invention provides a system for creating a model that relates one or more (preferably two, three, four or more) measurable tissue properties to one or more tissue characteristics, the system comprising:
a database of training data sets, the data sets each being assigned to one or more of a plurality of categories;
a user interface for defining a group of training data sets to be used to build a model, the group being defined with reference to two or more of the data categories; and
a model generator for creating the model using the defined group of data sets.

This ability to build a model from selected data having specific properties (as determined by the categories) may be useful, for instance, to build models that are more representative of a particular patient for whom a tissue sample that is being analysed using the model has been taken. For example, it may provide more accurate results if a model used to analyse breast tissue from a 45 year old women who has never had children is created using data sets for tissue samples from females in the 40 to 50 age range who have not carried a foetus.

Models may be generated as and when they are needed in this way. More preferably, however, once a model has been created it is stored in a database of models so that it can be re-used, It may be convenient to generate a library of models in this way, so that in use one of the library of models can be used as an alternative to building a bespoke model. Where such a library of models exists, each model is preferably updated as new, relevant training data sets become available (especially if the new data is of higher accuracy than the existing data used to create the model).

In a fourth aspect, the invention provides a database structure for storing a plurality of measured tissue property data sets;
for each data set the database structure storing one or more tissue characteristics (e.g. normal, abnormal benign, abnormal malignant) and one or more measured tissue properties (e.g. X-ray scatter signature at 7 degrees, Compton scatter measurement at 120 degrees, etc);
the database structure further comprising a plurality of categories, wherein each data set can be associated with one or more of the plurality of categories in the database structure.

Preferably the categories are arranged in a plurality of category types, each category type containing one or more categories. The categories within a category type may be mutually exclusive, wherein each data set can only be associated with one of the categories in that category type.

The invention also provides models created and trained in accordance with the various aspects above.

### BRIEF DESCRIPTION OF THE DRAWINGS

An embodiment of the invention is described below by way of example with reference to the accompanying drawings, in which:

FIG. 1 is a schematic drawing of a model generating system in accordance with a first embodiment of the invention;

FIG. 2 illustrates a database structure used in the system of FIG. 1;

FIG. 3 illustrates a model generating system in accordance with further embodiments of the invention; and

FIGS. 4, 5 and 6 show a process, according to an embodiment of the invention, for generating models using the system of FIG. 3.

### DESCRIPTION OF EMBODIMENTS

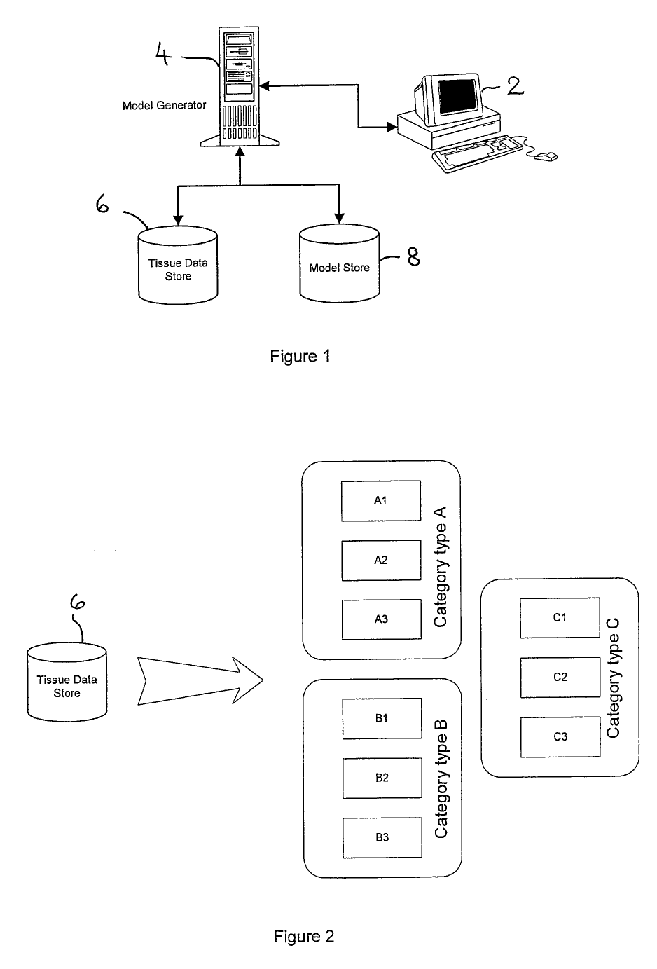

FIG. 1 illustrates a system that can be used to create models, based on training sets of tissue data, which can subsequently be used to characterise tissue samples. The model may be used, for example, in the analysis of biopsy material (or in other in vitro tests) or for in vivo analysis to characterise tissue as normal, abnormal benign or abnormal malignant.

The system is controlled by an operator from a networked PC (personal computer) 2 in this example. The PC controls, under the direction of the operator, a model generator server 4, which has access to two databases, as tissue data store 6 and a model store 8.

The model store 8 is a database holding copies of the models that have been generated, so that they can be recalled for use at a later date.

The tissue data store 6 is a database holding multiple training data sets. Each training data set comprises measured tissue property data for a single tissue sample having one or more known characteristics. The characteristics are also stored as part of the training data set. For example, the tissue property data might include low- and wide-angle scatter measurements, Compton scatter measurements, transmission measurements and XRF measurements obtained by irradiating the tissue sample with X-ray radiation. One tissue characteristic, in this example, would be one of normal, abnormal benign and abnormal malignant. Another tissue characteristic might be tissue type, e.g. fibrous or adipose.

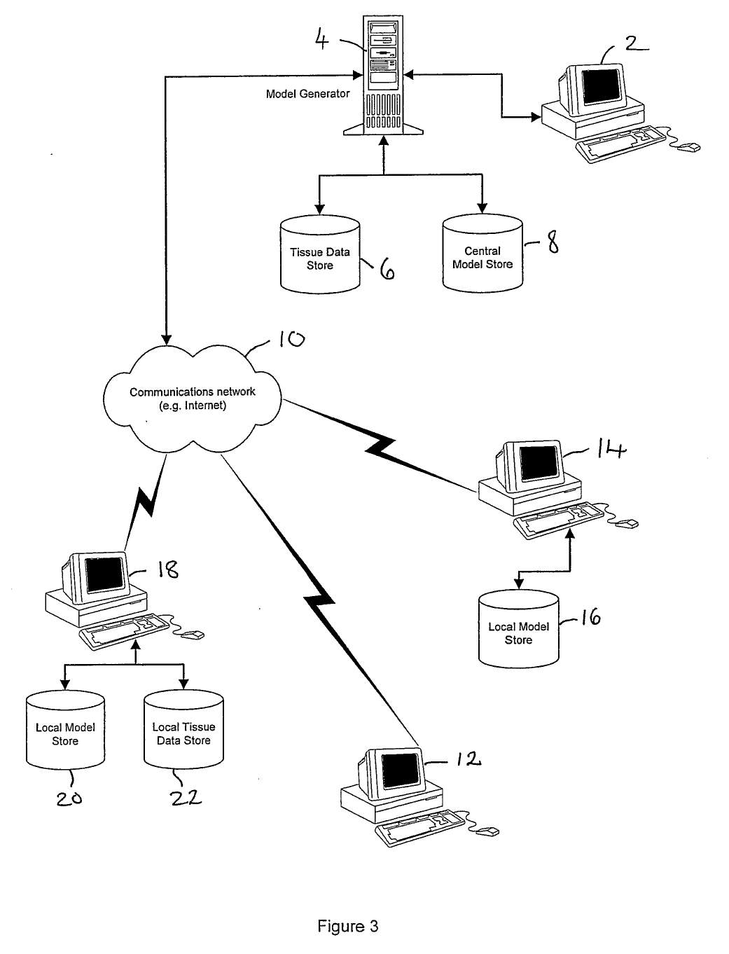

As shown in FIG. 2, the data structure of the tissue data store database 6 includes a plurality of categories grouped in a plurality of category types. For the purposes of illustration,

FIG. 2 shows three category types (types ‘A’, ‘B’ and ‘C’) and each category type contains three categories (categories ‘A1’, ‘A2’, ‘A3’, ‘B1’, etc). In practice there may be many more category types and fewer or more categories within each type. The category types/categories each represent some property of the tissue samples of the patient from which they have been obtained. For example, category type ‘A’ might be ‘sex’, ‘A1’ being ‘female’, ‘A2’ ‘male’ and ‘A3’ being ‘unknown’. Category type ‘B’ might be ‘age’, ‘B1’ being ‘20 to 30’, ‘B2’ ‘31 to 40’ and ‘B3’ ‘41 to 50’. Category type ‘C’ might be ‘location’, with ‘C1’ being ‘Europe’, ‘C2’ being ‘North America’ and ‘C2’ being ‘Elsewhere’.

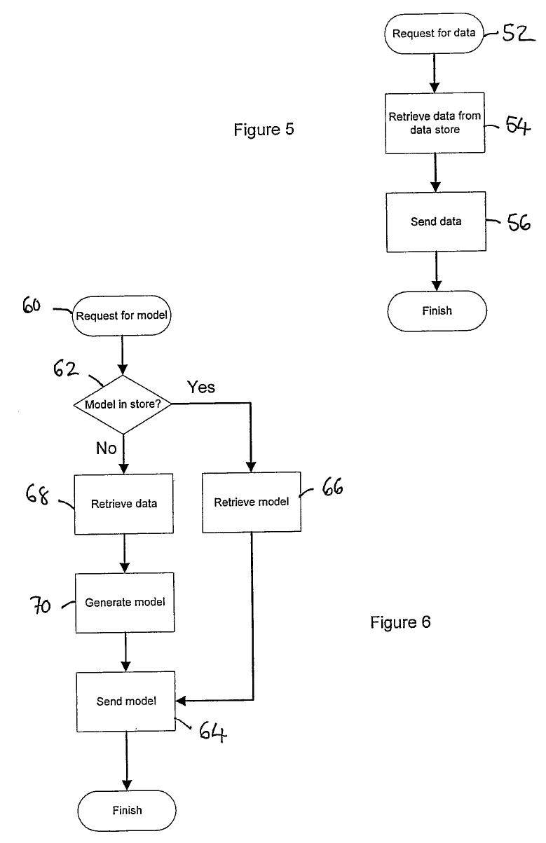

In use, the operator directs the generation of a model by specifying which categories of data the model should be based on. The relevant data is retrieved from the data store 6 and the model created by the model generator 4. Once created, the model is saved in the model store 8 and can be used to analyse (e.g. characterise) other tissue samples. This process is described in more detail below with reference to FIGS. 4 through 6.

The method of model creation, once the data to be used has been selected, can be any of a number of suitable modelling methods known in the computer modelling field. Suitable examples include the Partial Least Squares (PLS) regression and Principal Component Analysis (PCA) approaches described in co-pending PCT patent application PCT/GB04/005185. The models, once generated, can be used in accordance with the analysis/tissue characterisation methods described in that application.

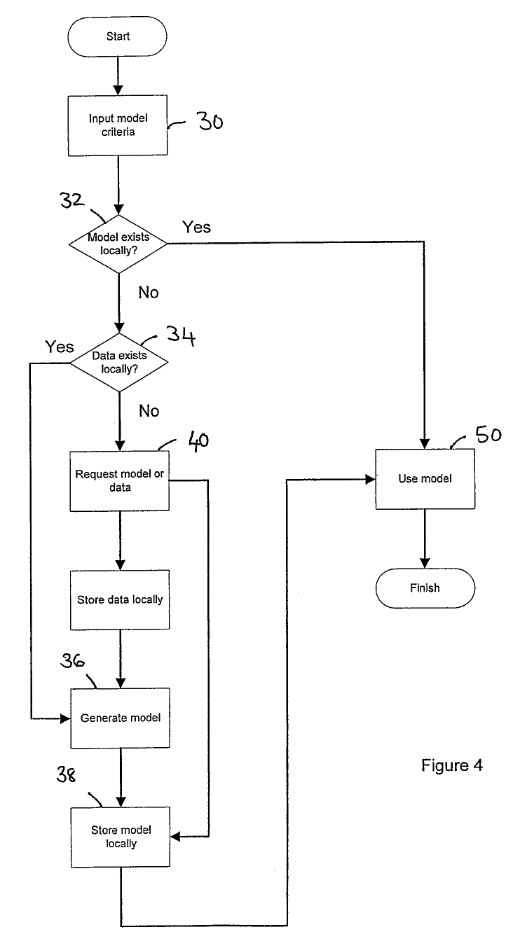

FIG. 3 illustrates an extension of the system of FIG. 1, which enables models to be retrieved and created fur use at remote sites.

Any number of users located remotely from the central model generator 4 with its associated central tissue data and model stores 6,8 can access these facilities via, for example, the Internet 10. Three such remote users are illustrated in FIG. 3.

A first remote user 12 simply has a PC locally, which can be used in the same way as the PC 2 connected directly to the model generator 4 to operate the model generator 4. The only difference is that the communication between the remote PC 12 and the model generator 4 is via the Internet 10. Once the model is generated, as well as being saved to the model store 8 it is sent to the remote PC 12 for use there.

Remote user 14 operates in a similar manner. However, they also have access to a local model store 16. This enables models generated at the request of remote user 14 to be stored locally by that user as well as storing them centrally. This may be advantageous to minimise the need for communication with the central system, particularly where the same model or models are used on a regular basis by the remote user 14.

Remote user 18 also has a local model store 20. In addition, they also have access to a local tissue data store 22. The local tissue data store 22 may be a mirror of the whole or selected parts of (e.g. selected categories of data) the central tissue data store 6. This means that some requests for new models by remote user 18 may be possible to fulfil locally without the need to communicate with the central system (the remote user's PC 18 including a model generation facility).

The mode of operation of the system of FIG. 3 will now be described with reference to FIGS. 4 to 6. FIG. 4 illustrates the process steps at the remote user's PCs 12,14,18. FIGS. 5 and 6 illustrate processes at the central system, specifically the model generator 4.

Looking initially at FIG. 4, when a user requires a model to carry out a tissue analysis process, they first input the desired model criteria 30. These criteria correspond to the tissue data store database categories. A user may, for example, specify a model generated using data for females in the 31 to 40 age bracket (i.e. data sets categorised as both ‘A1’ and ‘B2’).

The system then checks to see if the model already exists in a local model store (if there is one) 32. If it does, the locally stored model can be used 50. No new model need be created and no communication with the central system is required.

If a model with the required specification does not already exist locally, the system next checks to see if the data necessary to create the desired model exists locally (where there is a local tissue data store) 34. If it does, the new model can be generated locally 36, stored locally 38 and used 50.

If neither the model nor the data to create it exist locally, the local system must look to the central system to provide them. The local system therefore requests 40 either the desired model or the data required to generate it from the central system as the case may be.

In the case of a request for data 52 received by the central system, as illustrated in FIG. 5, the central system merely retrieves the necessary data from its data store 54 and sends it 56 to the remote system that has requested it.

Where the request 60 is for a model (see FIG. 6), the central system first checks 62 to see if a model with the correct specification already exists in the central model store. If it does, the central system retrieves 66 the stored model and sends it 64 to the requesting remote system.

If an appropriate model does not already exist, the central system (specifically the model generator) creates a new model to the desired specification. To do this, the necessary data is first retrieved 68 from the central tissue data store and this data is then used to create the model 70. The new model is then sent 64 to the remote system from which the request was received. Where a new model is created in this way, it may also be saved to the central model store.

Returning to FIG. 3, in the case where a new model has been requested 40 from the central system, when the model is received at the remote system it is saved to the local model store 38 and can then be used 50.

In the case where only data has been requested 50, the remote system stores the received data to its local tissue data store (where there is one) and locally processes the data to generate the desired model 36. The model is then stored in the local model store 38 and can be used 50.

In this way, multiple users at multiple locations remote from the central system can operate the system to retrieve or generate models needed for tissue analysis/characterisation with the minimum necessary amount of Internet communication.

Models stored either centrally or locally at remote systems are preferably updated when relevant new tissue data becomes available. Similarly, where tissue data is stored locally at remote systems, relevant new data received at the central tissue data store is preferably copied to the local data store.

It will be appreciated that description above is given by way of example and various modifications, omissions or additions to that which has been specifically described can be made without departing from the invention.

1-18. (canceled)

19. A method of creating or updating a model for characterising body tissue as normal or abnormal, wherein the model relates to at least one measurable tissue property to at least one tissue characteristic, the method comprising:
defining two or more data categories;
assigning each of a plurality of training data sets to one or more of the data categories;
creating or updating the model using only data sets categorised in a selected one of the categories.

20. A method according to claim 19, wherein the model relates at least one measurable tissue property to a plurality tissue characteristics.

21. A method according to claim 19, wherein the model relates a plurality measurable tissue properties to at least one tissue characteristic.

22. A method according to claim 19, wherein the model relates a plurality measurable tissue properties to a plurality of tissue characteristics.

23. A method according to claim 19 which can subsequently be used to characterise a tissue sample based on a set of measured tissue property data from the sample.

24. A method according to claim 19, wherein a data set comprises multiple measured data values from a single tissue sample for which the tissue characteristic or characteristics are known.

25. A method according to claim 24, wherein the multiple measured values are from different types of measurement.

26. A method according to claim 25, wherein the multiple measured values comprise at least two selected from a group consisting of: x-ray fluorescence (XRF), Compton scatter or Compton scatter densitometry, energy dispersive x-ray diffraction (EDXRD), angular dispersive x-ray diffraction (including wide angle x-ray scattering (WAXS)), low angle x-ray scattering, small angle scattering (SAXS), and ultra low angle scattering (ULAX) and linear attenuation (transmission).

27. A method according to claim 19, wherein the data categories comprise at least one property of the tissue or the patient the tissue has been obtained from.

28. A method according to claim 19, wherein the training data sets are stored in a database with assigned categories.

29. A method according to claim 19, wherein new training data sets are categorised as they are added to the database.

30. A method according to claim 19, wherein each data set is assigned to multiple categories.

31. A method according to claim 30, wherein each data set has only one value for each category.

32. A method of creating a model for characterising body tissue as normal or abnormal, wherein the model relates at least one measurable tissue property to at least one tissue characteristic, the method comprising:
providing a database of training data sets, the data sets each being assigned to one or more of a plurality of categories;
defining a group of training data sets to be used to build a model, the group being defined with reference to two or more of the data categories; and
creating the model using the defined group of data sets.

33. A system for creating a model for characterising body tissue as normal or abnormal, wherein the model relates at least one measurable tissue property to at least one tissue characteristic, the system comprising:
a database of training data sets, the data sets each being assigned to one or more of a plurality of categories;
a user interface for defining a group of training data sets to be used to build a model, the group being defined with reference to two or more of the data categories; and
a model generator for creating the model using the defined group of data sets.

34. A database structure for storing a plurality of measured tissue property data sets for use in characterising body tissue as normal or abnormal;
for each data set the database structure storing at least one tissue characteristic and at least one measured tissue property;
the database structure further comprising a plurality of categories, wherein each data set can be associated with at least one of the plurality of categories in the database structure.

35. A database structure as claimed in claim 34, wherein the categories are arranged in a plurality of category types, and wherein each category type contains one or more categories.

36. A database structure as claimed in claim 35, wherein the categories within a category type are mutually exclusive, such that each data set can only be associated with one of the categories in that category type.
